(19) United States
(12) Patent Application Publication
(10) Pub. No.: US 2015/0220705 A1
(43) Pub. Date: Aug. 6, 2015

(54) METHOD AND DEVICE FOR GENERATING AN EXERCISE PLAN

(71) Applicant: KONINKLIJKE PHILIPS N.V., EINDHOVEN (NL)

(72) Inventors: Hong Lin, Suzhou (CN); Haonan Wu, Kaiserslautern (DE)

(21) Appl. No.: 14/417,619

(22) PCT Filed: Aug. 1, 2013
(86) PCT No.: PCT/IB2013/056319

§ 371 Date: Jan. 27, 2015

(30) Foreign Application Priority Data
Aug. 6, 2012 (CN) PCT/CN12/01039

(51) Int. Cl. G06F 19/00

(52) U.S. Cl. CPC G06F 19/3481

(57) ABSTRACT

The present invention relates to generation of an exercise plan. In an embodiment of the present invention, a method for generating an exercise plan from a plurality of exercises for a user is proposed. Each exercise of the plurality of exercises is associated with a parameter for indicating the status of said each exercise of the plurality of exercises. The parameter may be set to different values. For example, the parameter may be set to a first value indicates that the associated exercise has not been selected to be part of the exercise plan; similarly, a second value indicates that the associated exercise has been selected to be part of the exercise plan; and a third value indicates that the associated exercise has been performed by the user. The method can comprise the steps of: a) initializing the parameter of each exercise of the plurality of exercises into the first value; b) selecting a subset of exercises from the plurality of exercises to generate the exercise plan and updating the parameter of each selected exercise in the plurality of exercises into the second value; and c) updating the exercise plan based on the user's performance resulting from the execution of the exercise plan and the parameter associated with each exercise of the plurality of exercises. With the proposed method, an exercise plan can be generated and updated conveniently. The invention also proposes a device for generating an exercise plan.

### FIELD OF THE INVENTION

The invention relates to generation of an exercise plan, and more specifically to method and device for generating an exercise plan from a plurality of exercises for a user.

### BACKGROUND OF THE INVENTION

Serious illnesses such as a stroke, or surgical operations such as the insertion of joint implants may be the cause of disability of a user. For example, after a stroke, the region of the brain responsible for controlling a muscle or a number of muscles in a functional chain, may be damaged. Thus, the affected muscles degenerate. The user should do exercises to train the affect muscles and joints in order to, at least partially, restore the lost functions.

It has been proposed to solve the problem of how to determine the proper plurality of exercises to be done by the user according to his current health state. In practice, however, the determined plurality of exercises is always too many for the user to do in one session. In this respect, no relative processing concerns with how to generate an exercise plan from the determined exercises for the user or how to update the exercise plan.

### SUMMARY OF THE INVENTION

It would be desirable to obviate at least some of the above disadvantages and provide a method and device for generating an exercise plan from a plurality of exercises for a user.

To better address one or more of these concerns, in a first aspect of the invention, a method for generating an exercise plan from a plurality of exercises for a user is proposed. Each exercise of the plurality of exercises is associated with a parameter for indicating the status of said each exercise of the plurality of exercises. The parameter can be set to different value. For example, when the parameter is set to a first value, it indicates that the associated exercise has not been selected to be part of the exercise plan; similarly, a second value indicates that the associated exercise has been selected to be part of the exercise plan; and a third value indicates that the associated exercise has been performed by the user. The method can comprise the steps of: a) initializing the parameter of each exercise of the plurality of exercises into the first value; b) selecting a subset of exercises from the plurality of exercises to generate the exercise plan and updating the associated parameter of each selected exercise in the plurality of exercises into the second value; and c) updating the exercise plan based on the user's performance resulting from the execution of the exercise plan and the parameter associated with each exercise of the plurality of exercises.

Due to the above method, an exercise plan can be generated from a plurality of exercises for a user and the generated exercise plan can be updated conveniently.

In one embodiment, the step c) of the method can comprise at least one of the following steps: c1) deleting at least one exercise from the exercise plan based on the user's performance resulting from the execution of the exercise plan and updating the parameter of each deleted exercise in the plurality of exercises into the third value; and c2) adding at least one exercise with the first value from the plurality of exercises into the exercise plan and updating the parameter of each added exercise in the plurality of exercises into the second value.

In another embodiment, the step c) can further comprise a step c3) before the step c2): determining whether the number of the exercises with the first value is larger than or equal to the difference between the number of the exercises in the subset and the number of the exercises with the second value. When the step c3) is comprised, the addition of at least one exercise with the first value from the plurality of exercises into the exercise plan in the step c2) can comprise: if the number of the exercises with the first value is larger than or equal to the difference between the number of the exercises in the subset and the number of the exercises with the second value, adding at least one exercise with the first value from the plurality of exercises into the exercise plan so that the sum of the number of the added exercise and the number of the exercises with the second value is equal to the number of the exercises in the subset; or, if the number of the exercises with the first value is not larger than or equal to the difference between the number of the exercises in the subset and the number of the exercises with the second value, adding all the exercises with the first value from the plurality of exercises into the exercise plan.

In another embodiment, the step c) can further comprise a step c4) after the step c2): determining whether a predefined condition is met, and updating the parameter of each of all the exercises with the third value into the first value if the predefined condition is met. For example, the predefined condition can be that the number of the exercises with the first value is less than half of the number of the exercises in the subset.

In a further embodiment, the method can further comprise returning to the step c1) after the step c4) is performed and repeating the steps c1), c3), c2) and c4) at least one time.

In a second aspect of the invention, a device for generating an exercise plan from a plurality of exercises for a user is proposed. Each exercise of the plurality of exercises is associated with a parameter for indicating the status of said each exercise of the plurality of exercises. The parameter can be set to different value. For example, when the parameter is set to a first value, it may indicate that the associated exercise has not been selected to be part of the exercise plan; similarly, a second value may indicate that the associated exercise has been selected to be part of the exercise plan; and a third value may indicate that the associated exercise has been performed by the user. The device can comprise: a first unit, configured to initialize the parameter of each exercise of the plurality of exercises into the first value; a second unit, configured to select a subset of exercises from the plurality of exercises having been initialized to generate the exercise plan and update the parameter of each selected exercise in the plurality of exercises into the second value; and a third unit, configured to update the exercise plan based on the user's performance resulting from the execution of the exercise plan and the parameter associated with each exercise of the plurality of exercises.

In one embodiment, the third unit can comprise: a first subunit, configured to delete at least one exercise from the exercise plan based on the user's performance resulting from the execution of the exercise plan and update the parameter of each deleted exercise in the plurality of exercises into the third value; and a second subunit, configured to add at least one exercise with the first value from the plurality of exercises into the exercise plan from which at least one exercise has been deleted and update the parameter of each added exercise in the plurality of exercises into the second value.

In another embodiment, the third unit can further comprise a third subunit, which is configured to, for the plurality of exercises in which the parameter of each deleted exercise deleted from the exercise plan has been updated into the third value, determining whether the number of the exercises with the first value is larger than or equal to the difference between the number of the exercises in the subset and the number of the exercises with the second value. When the third subunit is comprised, the second subunit can be further configured to: if the number of the exercises with the first value is larger than or equal to the difference between the number of the exercises in the subset and the number of the exercises with the second value, add at least one exercise with the first value from the plurality of exercises into the exercise plan from which at least one exercise has been deleted so that the sum of the number of the added exercise and the number of the exercises with the second value is equal to the number of the exercises in the subset; or, if the number of the exercises with the first value is not larger than or equal to the difference between the number of the exercises in the subset and the number of the exercises with the second value, add all the exercises with the first value from the plurality of exercises into the exercise plan from which at least one exercise has been deleted.

In another embodiment, the third unit can further comprise a fourth subunit, which is configured to, for the plurality of exercises in which the parameter of each added exercise added into the exercise plan has been updated into the second value, determine whether a predefined condition is met and update the parameter of each of all the exercises with the third value into the first value if the predefined condition is met. For example, the predefined condition can be that the number of the exercises with the first value is less than half of the number of the exercises in the subset.

In a further embodiment, the operations of the first subunit, the third subunit, the second subunit and the fourth subunit can be repeated at least one time.

In a third aspect of the invention, it is proposed an information medium, which is configured to store a program loaded and executed by a data processing device to perform method(s) according to the embodiment(s) of the present invention.

These and other aspects of the invention will be apparent from and elucidated with reference to the embodiments described hereinafter.

### BRIEF DESCRIPTION OF THE DRAWINGS

The proposed method and device for generating an exercise plan from a plurality of exercises for a user will be described in the following by way of examples and with reference to the accompanying drawings, without limiting the scope of protection as defined by the claims. In the Figures:

FIG. 1 schematically shows a flow chart of a method for generating an exercise plan from a plurality of exercises for a user according to an embodiment of the present invention;

FIG. 2 schematically shows a flow chart of a method for generating an exercise plan from a plurality of exercises for a user according to another embodiment of the present invention;

FIG. 3 schematically shows a flow chart of a method for generating an exercise plan from a plurality of exercises for a user according to a further embodiment of the present invention;

FIG. 4 is a schematic view of a device for generating an exercise plan from a plurality of exercises for a user according to an embodiment of the present invention;

FIG. 5 is a schematic view of a device for generating an exercise plan from a plurality of exercises for a user according to another embodiment of the present invention; and

FIG. 6 is a schematic view of a device for generating an exercise plan from a plurality of exercises for a user according to a further embodiment of the present invention.

### DETAILED DESCRIPTION OF EMBODIMENTS

While the invention covers various modifications and alternative constructions, embodiments of the invention are shown in the drawings and will hereinafter be described in detail. However, it should be understood that the specific description and drawings are not intended to limit the invention to the specific forms disclosed. On the contrary, it is intended that the scope of the claimed invention includes all modifications and alternative constructions thereof falling within the scope of the invention as expressed in the appended claims.

As described above, for a user, such as a patient to be rehabilitated, it may be desirable to generate an exercise plan from a plurality of exercises for him/her and/or to update the exercise plan. However, no relative processing focuses on this respect currently. The inventor has recognized this situation and proposed a mechanism to address this issue.

Suppose the exercise plan can be generated from a plurality of exercises which are determined in advance. To generate and update the exercise plan conveniently, the inventor has proposed to make each exercise of the plurality of exercises associated with a parameter. For example, the parameter can be set to different value for indicating the different status of the exercise. For example, a first value first value indicates that the associated exercise has not been selected to be part of the exercise plan, i.e. the first value is associated with an “Unselected” status of the exercise; a second value indicates that the associated exercise has been selected to be part of the exercise plan, i.e. the second value is associated with a “Selected” status of the exercise; and a third value indicates that the associated exercise has been performed by the user, i.e. the third value is associated with a “Done” status of the exercise. When the plurality of exercises is initialized, the parameter of each exercise of the plurality of exercises is initialized into the first value. Then, some of exercises are selected from the plurality of exercises to generate the exercise plan, and the parameter of each selected exercise in the plurality of exercises is updated into the second value. After the user finishes doing the exercise plan and gets back with exercise performance, the exercise plan can be updated based on the user's performance and the parameter associated with each exercise of the plurality of exercises.

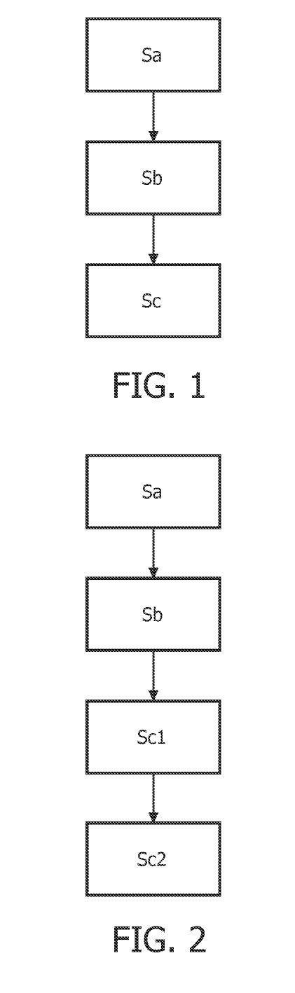

FIG. 1 schematically shows a flow chart of a method for generating an exercise plan from a plurality of exercises for a user according to an embodiment of the present invention.

Each exercise of the plurality of exercises can be associated with a parameter for indicating the status of said each exercise of the plurality of exercises. The parameter can be set to the first value for indicating that the associated exercise has not been selected to be part of the exercise plan; or can be set to the second value for indicating that the associated exercise has been selected to be part of the exercise plan; or can be set to the third value for indicating that the associated exercise has been performed by the user. As shown in FIG. 1, the method can comprise at least the following steps: at step Sa, the parameter of each exercise of the plurality of exercises is initialized into the first value; at step Sb, a subset of exercises is selected from the plurality of exercises to generate the exercise plan and the parameter of each selected exercise in the plurality of exercises is updated into the second value; and at step Sc, the exercise plan is updated based on the user's performance resulting from the execution of the exercise plan and the parameter associated with each exercise of the plurality of exercises.

FIG. 2 schematically shows a flow chart of a method for generating an exercise plan from a plurality of exercises for a user according to another embodiment of the present invention.

For clarify and simplicity, for the steps identical to those in the method as shown in FIG. 1, no further explanation will be provided.

As shown in FIG. 2, the method for generating an exercise plan from a plurality of exercises for a user according to this embodiment can comprise steps Sa and Sb which are identical to those in the method as shown in FIG. 1. Furthermore, the step Sc in the method according to this embodiment can comprise at least two substeps: at step Sc1, at least one exercise from the exercise plan is deleted based on the user's performance resulting from the execution of the exercise plan and the parameter of each deleted exercise in the plurality of exercises is updated into the third value; and at step Sc2, at least one exercise with the first value is added from the plurality of exercises into the exercise plan and the parameter of each added exercise in the plurality of exercises is updated into the second value.

In the method as shown in FIG. 2, the exercise plan can be updated by deleting at least one exercise from the exercise plan based on the user's performance and adding at least one exercise with “Unselected” status into the exercise plan.

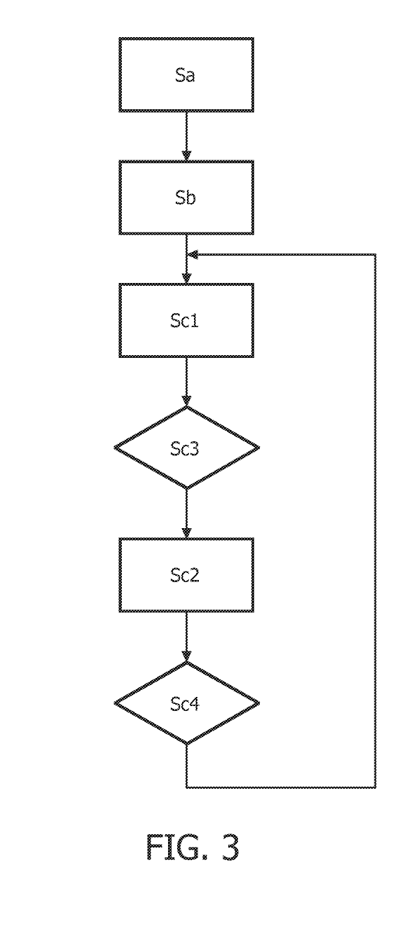

FIG. 3 schematically shows a flow chart of a method for generating an exercise plan from a plurality of exercises for a user according to a further embodiment of the present invention.

For clarify and simplicity, for the steps identical to those in the methods as shown in FIG. 2, no further explanation will be provided.

As shown in FIG. 3, the method for generating an exercise plan from a plurality of exercises for a user according to this embodiment can comprise steps Sa, Sb, Sc1 and Sc2 which are identical to those in the method as shown in FIG. 2. Furthermore, the step Sc in the method according to this embodiment can further comprise an optional substep Sc3 before the substep Sc2. At the step Sc3, whether the number of the exercises with the first value is larger than or equal to the difference between the number of the exercises in the subset and the number of the exercises with the second value is determined.

If the substep Sc3 is performed, the addition of at least one exercise with the first value from the plurality of exercises into the exercise plan in the substep Sc2 can comprise: if the number of the exercises with the first value is larger than or equal to the difference between the number of the exercises in the subset and the number of the exercises with the second value, at least one exercise with the first value is added from the plurality of exercises into the exercise plan so that the sum of the number of the added exercise and the number of the exercises with the second value is equal to the number of the exercises in the subset; or, if the number of the exercises with the first value is not larger than or equal to the difference between the number of the exercises in the subset and the number of the exercises with the second value, all the exercises with the first value are added from the plurality of exercises into the exercise plan.

Due to the substeps Sc3 and Sc2, it is possible to keep a desired number of exercises in the exercise plan.

Optionally, the step Sc in the method according to this embodiment can further comprise a substep Sc4 after the substep Sc2. At the step Sc4, whether a predefined condition is met is determined and the parameter of each of all the exercises with the third value is updated into the first value if the predefined condition is met.

In practice, the predefined condition can be set or determined according to applications and/or requirements. For example, the predefined condition can be that the number of the exercises with the first value is less than half of the number of the exercises in the subset. But it should be understood that the specific example is not intended to limit the scope of the invention.

In some cases, it may be desirable to keep updating the exercise plan. To address this concern, optionally, the method can further comprise returning to the step c1) after the step c4) is performed and repeating the steps c1), c3), c2) and c4) at least one time, as shown in FIG. 3.

Due to the optional step Sc4, the parameters of all the exercises with the third value can be updated into the first value (from “Done” status into “Unselected” status) when there are less exercises with the first value (“Unselected” status) existing in the plurality of exercises. Therefore, it is possible to continue doing the update of the exercise plan.

In practice, there are many ways for evaluating the user's performance. The following Table 1 is merely an example of evaluating the user's performance. It should be understood that the specific example is not intended to limit the scope of the invention. A skilled person can determine or select the way for evaluating the user's performance according to applications and/or requirements.

TABLE 1

| Error | Description | Evaluation |
|---|---|---|
| Not Reach | Whether the user can reach | Good: <30% repetition |
| the Range | the target exercise need | exercise cannot reach target |
| | | Poor: ≧30% repetition |
| | | exercise cannot reach target |
| Trunk Move | Whether trunk move | Good: <20% repetition |
| | happened during the user | exercise with trunk move |
| | does exercise | Poor: ≧20% repetition |
| | | exercise with trunk move |
| Speed Control | Whether the user do well | Good: <20% repetition |
| | on speed control | exercise with speed is too |
| | | fast |
| | | Poor: ≧20% repetition |
| | | exercise with speed is too |
| | | fast |
| Elbow Move | Whether elbow move | Good: <20% repetition |
| | happened during the user | exercise with elbow move |
| | does exercise | Poor: ≧20% repetition |
| | | exercise with elbow move |

As an example, suppose each exercise needs to be practiced with several repetitions by the user. And each repetition has four attributes to show whether the user does the exercise with some error or not. Finally all attributes of all the repetitions can be summarized to only two kinds of results: Good and Poor. If any error item gets Poor performance, the exercise summary performance is Poor; else the exercise summary performance is Good. The detail information of attributes can be got in the above Table 1.

As described above, in the method(s) for generating an exercise plan from a plurality of exercises for a user according to embodiment(s) of the present invention, the exercise plan can be updated based on the user's performance. For example, if the above Table 1 is used for evaluating the user's performance, the good performed exercise(s) can be deleted from the exercise plan and the poor performed exercise(s) can be remained in the exercise plan. In another example, the good performed exercise(s) can be deleted from the exercise plan, while for the poor performed exercise(s), there are two situations: if the poor performance results from any one of the reasons of Trunk Move, Elbow Move and Speed control, such poor performed exercise(s) can be deleted from the exercise plan; or else, if the poor performance results from other reason, such poor performed exercise(s) can be remained in the exercise plan.

Some or all of the steps of the methods as described above may alternatively be implemented by a data processing device in combination with e.g. a computer program. The computer program comprises computer readable code which when loaded and executed by the data processing device, enables at least some steps of any of the methods described herein to be performed. The computer program may be stored on an information medium.

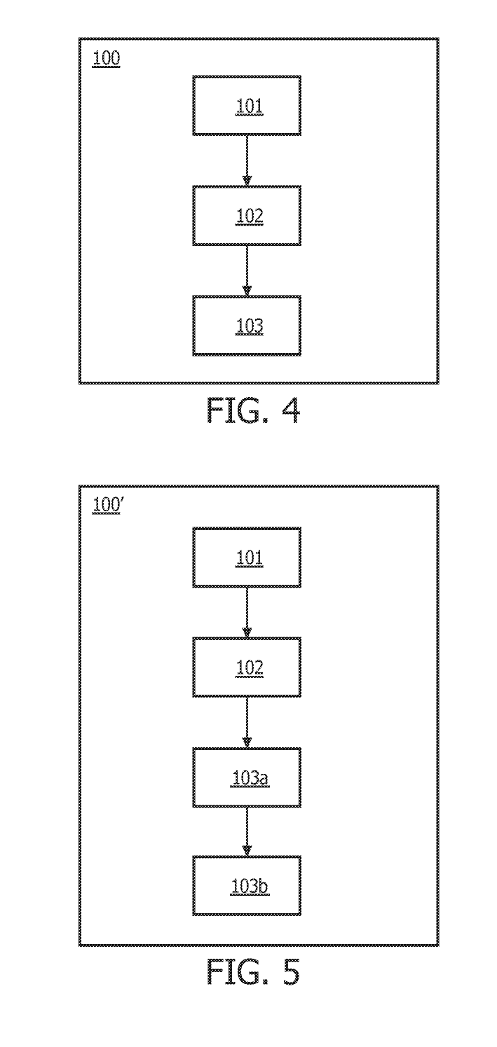

FIG. 4 is a schematic view of a device 100 for generating an exercise plan from a plurality of exercises for a user according to an embodiment of the present invention.

Each exercise of the plurality of exercises can be associated with a parameter for indicating the status of said each exercise of the plurality of exercises. The first value indicates that the associated exercise has not been selected to be part of the exercise plan; the second value indicates that the associated exercise has been selected to be part of the exercise plan; and the third value indicates that the associated exercise has been performed by the user. As shown in FIG. 4, the device 100 can comprise: a first unit 101, configured to initialize the parameter of each exercise of the plurality of exercises into the first value; a second unit 102, configured to select a subset of exercises from the plurality of exercises having been initialized to generate the exercise plan and update the parameter of each selected exercise in the plurality of exercises into the second value; and a third unit 103, configured to update the exercise plan based on the user's performance resulting from the execution of the exercise plan and the parameter associated with each exercise of the plurality of exercises.

Here, the device 100 is elucidated by way of units, while in practice, the device 100 can be implemented by way of either software, hardware or a combination thereof. For example, program codes achieving the functions of the above units can be stored in a memory. These codes can be loaded and executed by a processor in a computer to implement some or all of the functionality of all units of the device 100. In another example, special hardware circuits such as Application Specific Integrated Circuits (ASICs) or digital signal processor (DSP) may be used in practice to implement some or all of the functionality of all units of the device 100. For instance, certain IC chips can achieve the functions of the above units, and these chips can be controlled by an MCU to implement some or all of the functionality of all units of the device 100.

FIG. 5 is a schematic view of a device 100′ for generating an exercise plan from a plurality of exercises for a user according to another embodiment of the present invention.

For clarify and simplicity, for the units identical to those in the device as shown in FIG. 4, no further explanation will be provided.

As shown in FIG. 5, the device 100′ for generating an exercise plan from a plurality of exercises for a user according to this embodiment can comprise a first unit 101 and a second unit 102 which are identical to those in the device as shown in FIG. 4. Furthermore, the third unit in the device according to this embodiment can comprise at least two subunits: a first subunit 103a, which is configured to delete at least one exercise from the exercise plan based on the user's performance resulting from the execution of the exercise plan and update the parameter of each deleted exercise in the plurality of exercises into the third value; and a second subunit 103b, which is configured to add at least one exercise with the first value from the plurality of exercises into the exercise plan from which at least one exercise has been deleted and update the parameter of each added exercise in the plurality of exercises into the second value.

Here, the device 100′ is elucidated by way of units, while in practice, the device 100′ can be implemented by way of either software, hardware or a combination thereof. For example, program codes achieving the functions of the above units can be stored in a memory. These codes can be loaded and executed by a processor in a computer to implement some or all of the functionality of all units of the device 100′. In another example, special hardware circuits such as Application Specific Integrated Circuits (ASICs) or digital signal processor (DSP) may be used in practice to implement some or all of the functionality of all units of the device 100′. For instance, certain IC chips can achieve the functions of the above units, and these chips can be controlled by an MCU to implement some or all of the functionality of all units of the device 100′.

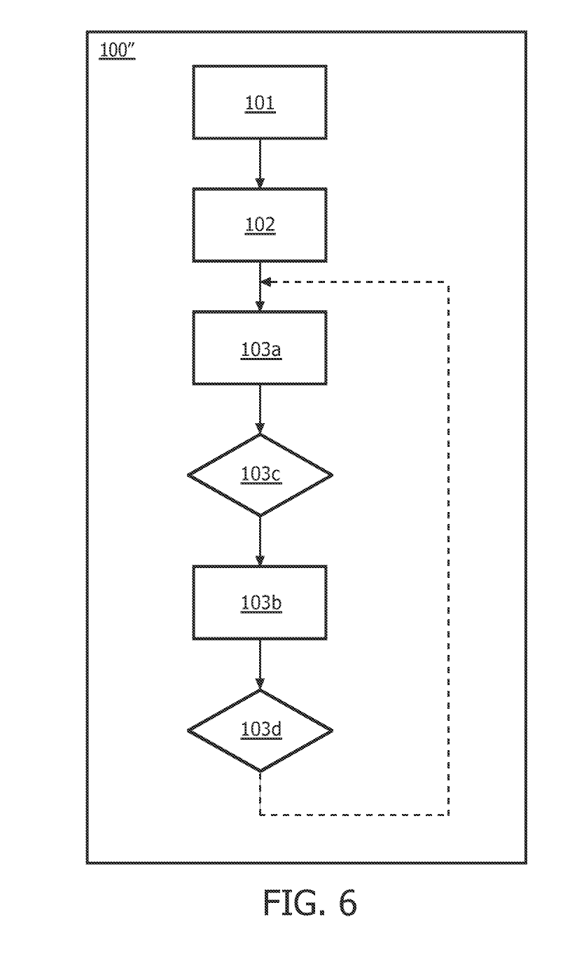

FIG. 6 is a schematic view of a device 100″ for generating an exercise plan from a plurality of exercises for a user according to a further embodiment of the present invention.

For clarify and simplicity, for the units or subunits identical to those in the device as shown in FIG. 5, no further explanation will be provided.

As shown in FIG. 6, the device 100″ for generating an exercise plan from a plurality of exercises for a user according to this embodiment can comprise a first unit 101, a second unit 102, a first subunit 103a of a third unit and a second subunit 103b of the third unit, which are identical to those in the device as shown in FIG. 5. Furthermore, the third unit in the device 100″ according to this embodiment can further comprise an optional third subunit 103c, which is configured to, for the plurality of exercises in which the parameter of each deleted exercise deleted from the exercise plan has been updated into the third value, determining whether the number of the exercises with the first value is larger than or equal to the difference between the number of the exercises in the subset and the number of the exercises with the second value.

When the device 100″ comprises the third subunit 103c, the second subunit 103b can be further configured to: if the number of the exercises with the first value is larger than or equal to the difference between the number of the exercises in the subset and the number of the exercises with the second value, add at least one exercise with the first value from the plurality of exercises into the exercise plan from which at least one exercise has been deleted so that the sum of the number of the added exercise and the number of the exercises with the second value is equal to the number of the exercises in the subset; or, if the number of the exercises with the first value is not larger than or equal to the difference between the number of the exercises in the subset and the number of the exercises with the second value, add all the exercises with the first value from the plurality of exercises into the exercise plan from which at least one exercise has been deleted.

Optionally, the third unit in the device 100″ according to this embodiment can further comprise a fourth subunit 103d, which is configured to, for the plurality of exercises in which the parameter of each added exercise added into the exercise plan has been updated into the second value, determine whether a predefined condition is met and update the parameter of each of all the exercises with the third value into the first value if the predefined condition is met.

In practice, the predefined condition can be set or determined according to applications and/or requirements. For example, the predefined condition can be that the number of the exercises with the first value is less than half of the number of the exercises in the subset. But it should be understood that the specific example is not intended to limit the scope of the invention.

In some cases, it may be desirable to keep updating the exercise plan. To address this concern, optionally, the operations of the first subunit 103a, the third subunit 103c, the second subunit 103b and the fourth subunit 103d can be repeated at least one time, as shown in FIG. 6.

Here, the device 100″ is elucidated by way of units, while in practice, the device 100″ can be implemented by way of either software, hardware or a combination thereof. For example, program codes achieving the functions of the above units can be stored in a memory. These codes can be loaded and executed by a processor in a computer to implement some or all of the functionality of all units of the device 100″. In another example, special hardware circuits such as Application Specific Integrated Circuits (ASICs) or digital signal processor (DSP) may be used in practice to implement some or all of the functionality of all units of the device 100″. For instance, certain IC chips can achieve the functions of the above units, and these chips can be controlled by an MCU to implement some or all of the functionality of all units of the device 100″.

It should be understood that, although the present invention can be applied for generating an exercise plan for rehabilitation of a user, such as a patient, it is not intended to limit the present invention into such application. For example, the present invention can also be used for generating an exercise plan for training in sports or for losing weight. These and other applications still fall within the scope of the present invention.

While the invention has been illustrated and described in detail in the drawings and foregoing description, such illustration and description are to be considered illustrative or exemplary and not restrictive. The invention is not limited to the disclosed embodiments. The different embodiments described above and in the claims can also be combined. Other variations to the disclosed embodiments can be understood and effected by those skilled in the art in practicing the claimed invention, from the study of the drawings, the disclosure and the appended claims.

In the claims, the word “comprising” does not exclude other elements or steps, and the indefinite article “a” or “an” does not exclude a plurality. The mere fact that measures are recited in mutually different dependent claims does not indicate that a combination of these measures can not be used to advantage. The reference signs in the claims should not be construed as limiting the scope of these claims.

1. A method for generating an exercise plan from a plurality of exercises for a user, each exercise of the plurality of exercises being associated with a parameter for indicating the status of said each exercise of the plurality of exercises, the method comprising the steps of:
a) initializing the parameter of each exercise of the plurality of exercises into a first value for indicating that the associated exercise has not been selected to be part of the exercise plan;
b) selecting a subset of exercises from the plurality of exercises to generate the exercise plan and updating the associated parameter of each selected exercise in the plurality of exercises into a second value for indicating said each selected exercise has been selected to be part of the exercise plan; and
c) after the user finishes doing the exercise plan, updating the exercise plan based on the user's performance resulting from the execution of the exercise plan and the parameter associated with each exercise of the plurality of exercises.

2. A method according to claim 1, wherein the step c) comprises at least one of following:
c1) deleting at least one exercise from the exercise plan based on the user's performance resulting from the execution of the exercise plan and updating the parameter of each deleted exercise in the plurality of exercises into a third value for indicating said each deleted exercise has been performed by the user; and
c2) adding at least one exercise with the first value from the plurality of exercises into the exercise plan and updating the parameter of each added exercise in the plurality of exercises into the second value.

3. A method according to claim 2, wherein the step c) further comprises a step c3) before the step c2) determining whether the number of the exercises with the first value is larger than or equal to the difference between the number of the exercises in the subset and the number of the exercises with the second value.

4. A method according to claim 3, wherein the addition of at least one exercise with the first value from the plurality of exercises into the exercise plan in the step c2) comprises:
if the number of the exercises with the first value is larger than or equal to the difference between the number of the exercises in the subset and the number of the exercises with the second value, adding at least one exercise with the first value from the plurality of exercises into the exercise plan so that the sum of the number of the added exercise and the number of the exercises with the second value is equal to the number of the exercises in the subset; or
if the number of the exercises with the first value is not larger than or equal to the difference between the number of the exercises in the subset and the number of the exercises with the second value, adding all the exercises with the first value from the plurality of exercises into the exercise plan.

5. A method according to claim 2, wherein the step c) further comprises a step c4) after the step c2): determining whether a predefined condition is met, and updating the parameter of each of the exercises with the third value into the first value if the predefined condition is met.

6. A method according to claim 5, wherein the predefined condition is that the number of the exercises with the first value is less than half of the number of the exercises in the subset.

7. A method according to claim 5, further comprising returning to the step c1) after the step c4) is performed and repeating the steps c1), c3), c2) and c4) at least one time.

8. A device for generating an exercise plan from a plurality of exercises for a user, each exercise of the plurality of exercises being associated with a parameter for indicating the status of said each exercise of the plurality of exercises, the device comprising:
a first unit, configured to initialize the parameter of each exercise of the plurality of exercises into a first value for indicating that the associated exercise has not been selected to be part of the exercise plan;
a second unit, configured to select a subset of exercises from the plurality of exercises having been initialized to generate the exercise plan and update the associated parameter of each selected exercise in the plurality of exercises into a second value for indicating said each exercise in the subset has been selected to be part of the exercise plan; and
a third unit, configured to, after the user finishes doing the exercise plan, update the exercise plan based on the user's performance resulting from the execution of the exercise plan and the parameter associated with each exercise of the plurality of exercises.

9. A device according to claim 8, wherein the third unit comprises:
a first subunit, configured to delete at least one exercise from the exercise plan based on the user's performance resulting from the execution of the exercise plan and update the parameter of each deleted exercise in the plurality of exercises into a third value for indicating said each deleted exercise has been performed by the user; and
a second subunit, configured to add at least one exercise with the first value from the plurality of exercises into the exercise plan from which at least one exercise has been deleted and update the parameter of each added exercise in the plurality of exercises into the second value.

10. A device according to claim 9, wherein the third unit further comprises a third subunit, configured to, for the plurality of exercises in which the parameter of each deleted exercise deleted from the exercise plan has been updated into the third value, determine whether the number of the exercises with the first value is larger than or equal to the difference between the number of the exercises in the subset and the another of the exercises with the second value.

11. A device according to claim 10, wherein the second subunit is further configured to:
if the number of the exercises with the first value is larger than or equal to the difference between the number of the exercises in the subset and the number of the exercises with the second value, add at least one exercise with the first value from the plurality of exercises into the exercise plan from which at least one exercise has been deleted so that the sum of the number of the added exercise and the number of the exercises with the second value is equal to the number of the exercises in the subset; or
if the number of the exercises with the first value is not larger than or equal to the difference between the number of the exercises in the subset and the number of the exercises with the second value, add all the exercises with the first value from the plurality of exercises into the exercise plan from which at least one exercise has been deleted.

12. A device according to claim 9, wherein the third unit further comprises a fourth subunit, configured to, for the plurality of exercises in which the parameter of each added exercise added into the exercise plan has been updated into the second value, determine whether a predefined condition is met and update the parameter of each of the exercises with the third value into the first value if the predefined condition is met.

13. A device according to claim 12, wherein the predefined condition is that the number of the exercises with the first value is less than half of the number of the exercises in the subset.

14. A device according to claim 12, wherein the operations of the first subunit, the third subunit, the second subunit and the fourth subunit are repeated at least one time.

15. An information medium, configured to store a program loaded and executed by a data processing device to perform a method according to claim 1.
